(19) United States
(12) Patent Application Publication
(10) Pub. No.: US 2025/0321146 A1
(43) Pub. Date: Oct. 16, 2025

(54) SENSOR PANEL

(71) Applicant: BLUEDROP MEDICAL LIMITED, GALWAY (IE)

(72) Inventors: SIMON KIERSEY, BARNA (IE); GAVIN CORLEY, ENNIS (IE); CHRISTOPHER MURPHY, DUBLIN (IE); ADAM COLLINS, GALWAY (IE)

(21) Appl. No.: 18/633,232

(22) Filed: Apr. 11, 2024

(51) Int. Cl. G01K 13/20; G01K 1/16; G01K 1/20; G01K 1/26

(52) U.S. Cl. CPC G01K 13/223; G01K 1/16; G01K 1/20; G01K 1/26

(57) ABSTRACT

A panel for a skin inspection device is described. The panel comprises a substrate; an array of temperature sensors; an interlayer comprising a material for thermally insulating the temperature sensors from the substrate.

### FIELD OF THE INVENTION

The present disclosure generally relates to an apparatus and method for identifying skin abnormalities. In particular, but not exclusively, the present disclosure relates to more accurate heat sensing, pressure sensing and visual inspection of a body part to predict the formation of ulcers.

### BACKGROUND

Diabetics commonly suffer from a condition known as diabetic foot ulcers (DFU) over their lifetime. It is recommended that diabetics inspect their feet daily so as detect any abnormalities of the skin that may be an indicator of the onset of DFU.

However, limiting factors such as reduced vision, reduced mobility, lack of sensation due to peripheral neuropathy, and a lack of education results in diabetics failing to adhere to daily foot inspections as recommended. Early identification of DFUs may result in improved outcomes and reduced medical treatment costs. If DFUs are detected before they form, the benefit would be even greater. Currently the best practice is to visually inspect the feet and report to a podiatrist periodically. Temperature monitoring is a known method of predicting DFU formation. A temperature difference of 2.2° C. between similar points on opposite feet has been shown to indicate inflammation which may be a precursor to ulceration.

Temperature point probes are known in the art which allow patients to take temperatures on the bottom of both feet so that temperature comparisons may be made from spot to spot. Such point probes may be used to measure skin temperature at individual target spots. If a spot on one foot demonstrates a change in temperature, compared to the same spot on the other foot, and sustains that change in temperature or higher (rises to four degrees Fahrenheit (2.2° C.) or more for two days or more) it indicates that a problem may be occurring and the patient is alerted to consult their doctor. The difficulty with this approach is that the same spot of the patient's foot requires measurement over a number of days. It is difficult for a patient to identify the same spot in order to accurately take measurements. Furthermore, the onus is on the patient to maintain a log of the temperature readings in order to do the comparisons which may result in human error. Daily visual inspection of the feet is recommended for all diabetics. As mentioned, this can be difficult due to poor vision and mobility. Current temperature monitoring devices do not facilitate the recommended daily visual inspection.

U.S. patent application Ser. No. 16/303,212 describes a skin inspection device for identifying skin abnormalities, wherein the patient steps onto a transparent panel (similar to a weighing scale) comprising an array of temperature sensors. The temperature sensors are positioned at discrete locations across the panel to record the temperature of the patient's feet at these discrete locations. The panel also comprises a substrate, which supports the weight of the patient. The prior art (e.g., U.S. Ser. No. 16/303,212 A1) describes that the temperature sensors are physically and thermally mated to the substrate which may be of a glass material. Finally, below these two layers (the temperature sensor layer and substrate) are one or more image capture devices for capturing an image of both the temperature sensors and the patient's feet, such that any abnormal temperature readings by the one or more discrete temperature sensors can be allocated to a particular position on the patient's foot. In this manner, the array of temperature sensors have associated addressable coordinates. A Central Processing Unit (CPU) is operable to associate one or more regions of the captured image to one or more addressable coordinates. The temperature sensors are spaced apart to facilitate optical transmission therebetween. The optical pathways are provided between adjacent temperature sensors. The optical pathways may be defined by a region between two or more adjacent temperature sensors. It is desirable to maximise the size of the optical pathways between the temperature sensors. The substrate onto which the temperature sensors are placed comprises a material which is both optically transparent, and of sufficiently high Young's Modulus such that it is strong enough to support the mass of the patient with negligible bending. Therefore, materials like glass are particularly suitable for this purpose. However, such materials (e.g., glass), usually have thermal properties which affect the temperature measurements. For instance, glass has a high thermal conductivity, meaning that the heat flux, which is the amount of energy transferred to the glass per unit area per unit time, is also high. This greater heat transfer results in a greater temperature change of the substrate (e.g., due to heat transfer from the ambient environment or foot etc.) and means that the temperature measured by the sensors is not only due to the temperature of the foot, but is also impacted by the temperature of the substrate. Clearly, this effect is undesirable as the resulting foot temperature measurement sensitivity may be reduced, and/or may be impacted by changes in ambient temperature.

For identifying skin abnormalities, it would thus be advantageous to provide a means for reducing this heat transfer effect to produce more sensitive temperature readings, which are less affected by ambient temperature changes.

### SUMMARY

The disclosure described herein provides a panel for a skin inspection device, wherein the panel comprises a substrate; an array of temperature sensors; an interlayer comprising a material for thermally insulating the temperature sensors from the substrate.

Optionally, the interlayer is at least partially transparent.

Typically, the interlayer has an optical absorption coefficient between 0.02 cm⁻¹ to 0.5 cm⁻¹ at a light wavelength of 587 nm.

Preferably, the interlayer has a sufficiently low thermal conductivity value, k, optionally in the range 0.02 W/mK to 0.3 W/mK.

Optionally, the interlayer is of sufficient thickness to thermally insulate the temperature sensors from the substrate.

Typically, the thickness of the interlayer is in the range 0.05 mm to 5 mm.

Preferably, the thickness of the interlayer provides sufficient thermal insulation whilst maintaining the transparency of the interlayer.

Optionally, the interlayer comprises at least one of the following materials: silica aerogel, air, Polyurethane (PU) foam, and transparent polymers such as polystyrene, polypropylene, polyester, PETG, PET, PMMA.

Preferably, the substrate is at least partially transparent.

Typically, the substrate is of a Young's Modulus of at least 40 GPa to support the weight of an adult.

Optionally, the substrate comprises glass.

Typically, the substrate comprises tempered glass.

Typically, the array of temperature sensors are provided on a carrier layer.

Preferably, the carrier layer is at least partially transparent.

In one aspect, the panel comprises a pressure-sensitive mechanism. Preferably, the pressure-sensitive mechanism comprises a pressure-sensitive layer. Advantageously, the pressure-sensitive layer comprises photoelastic material. In an exemplary arrangement, the photoelastic material has a refractive index which changes with applied pressure.

The disclosure described herein also provides a skin inspection device which comprises the panel as described above.

Preferably, the skin inspection device is configured to measure at least the temperature of an area of skin of one or more body parts.

Typically, the presence of an interlayer reduces the difference between the actual temperature of the area of skin and the temperature of the area of skin as measured by the skin inspection device.

Preferably, the skin inspection device is configured to allow calculation of a temperature difference between two or more body parts.

Typically, the temperature of the ambient environment of said device has no effect on the deduced temperature difference between the two or more body parts.

Typically, the skin inspection device is configured to measure the temperature of the ambient environment. Optionally, the skin inspection device may be configured to prevent temperature measurements if the ambient environment temperature is not within a predetermined range.

Optionally, the predetermined temperature range may be around 10° C. to 40° C.

Optionally, the skin inspection device comprises means by which to measure the temperature of the panel.

Preferably, the skin inspection device is configured to prevent temperature measurements if the panel temperature is not within a predetermined range.

The disclosure described herein also provides a method of manufacturing a panel for a skin inspection device, wherein the method comprises providing a substrate, providing an array of temperature sensors, and providing an interlayer comprising a material for thermally insulating the temperature sensors from the substrate.

Preferably, the interlayer used in said method is at least partially transparent.

Optionally, the interlayer used in said method has a sufficiently low thermal conductivity value, k.

Typically, the interlayer used in said method has a thermal conductivity k in the range 0.02 W/mK to 0.3 W/mK.

Preferably, the interlayer used in said method is of sufficient thickness to thermally insulate the temperature sensors from the substrate.

Optionally, the thickness of the interlayer used in said method is in the range 0.05 mm to 5 mm.

Typically, the thickness of the interlayer used in said method provides sufficient thermal insulation whilst maintaining the transparency of the interlayer.

Optionally, the interlayer used in said method comprises at least one of the following materials: silica aerogel, air, Polyurethane (PU) foam, and transparent polymers such as polystyrene, polypropylene, polyester, PETG, PET, PMMA.

### BRIEF DESCRIPTION OF DRAWINGS

FIG. 1 is a diagram of an exemplary sensor assembly for identifying skin abnormalities;

FIG. 2 is a diagram of an exemplary sensor panel;

FIG. 3 is an illustrative plot of the general trend of deflection of a panel with varying Young's Modulus and fixed thickness;

FIG. 4 is an illustrative plot of the deflection of a panel with varying panel thickness, and fixed Young's Modulus;

FIG. 4A is an exemplary graph comparing the thickness required of a potential substrate to maintain a 0.5 mm level of deflection;

FIG. 5 is an exemplary diagram of a panel according to one aspect of the present disclosure;

FIG. 6 is an exemplary diagram of a panel according to another aspect of the present disclosure;

FIG. 7A is an exemplary one-dimensional model of a panel with no interlayer present;

FIG. 7B is an exemplary one-dimensional model of a panel with an interlayer present;

FIG. 8 is an exemplary graph showing the difference between the actual temperature and the measured temperature versus time for varying interlayer thickness;

FIG. 9 is an exemplary graph showing the difference between the actual temperature and the measured temperature versus time for different thermal conductivity values;

FIG. 10 is an exemplary plot of measured temperature (T_{Measured}) versus actual foot temperature (T_{Actual}) with and without the presence of an interlayer;

FIG. 11 is an exemplary diagram illustrating the effects of an interlayer on the amount of light incident on a panel;

FIG. 12 is an illustrative plot of the reflection coefficient versus incident angle;

FIG. 13 is an exemplary diagram of different transparent materials, and the thermal conductivity of said material;

FIG. 14 is an exemplary diagram of a layer of the panel in the form of an air gap;

FIG. 15 is an exemplary diagram of cross sections of possible configurations of a panel;

FIG. 16 is an exemplary diagram demonstrating the enhanced safety of the panel with the presence of an interlayer;

FIG. 17 is an exemplary diagram illustrating a pressure-sensing functionality of a panel according to one aspect of the present disclosure;

FIG. 18 is another exemplary diagram further illustrating a pressure-sensing functionality of a panel;

FIG. 19 is an exemplary diagram showing a plan view of a pressure-sensing functionality of a panel.

### DETAILED DESCRIPTION

The present disclosure will now be described with reference to some exemplary skin inspection devices. It will be understood that the exemplary skin inspection devices are provided to assist in an understanding of the teaching and is not to be construed as limiting in any fashion. Furthermore, elements or components that are described with reference to any one figure may be interchanged with those of other figures or other equivalent elements without departing from the spirit of the present teaching. It will be appreciated that for simplicity and clarity of illustration, where considered appropriate, reference numerals may be repeated among the figures to indicate corresponding or analogous elements.

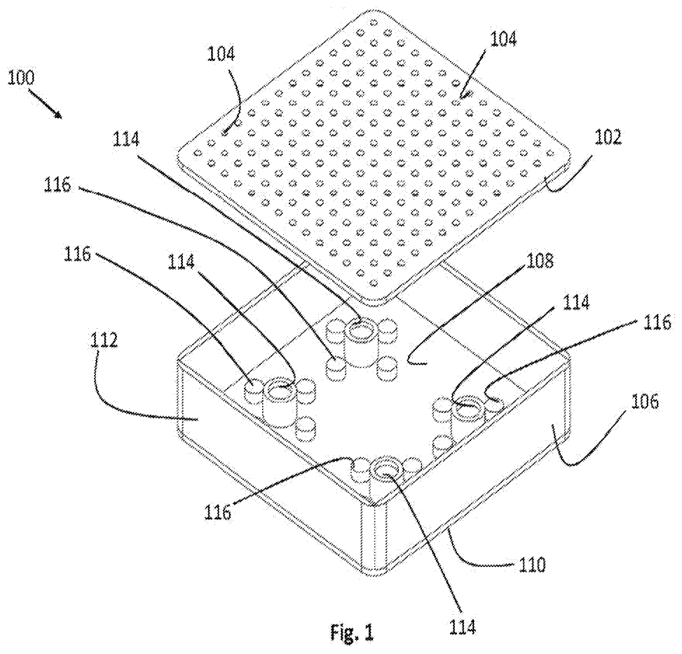

FIG. 1 is a diagram of an exemplary sensor assembly 100 for identifying skin abnormalities, comprising a panel 102 which defines an area for co-operating with a region of the body under inspection (for example, hand(s), a foot or feet, arm(s), leg(s) etc.). For the purposes of this disclosure, the region of the body under inspection is a foot but it is not intended to limit the present teaching to feet. Preferably, an array of temperature sensors 104 is provided on the panel 102 operable to record the temperature of the foot during inspection.

Preferably, the panel 102 may be supported on a housing 106 which may accommodate the components of the assembly 100 via interior 108. Typically, the housing 106 comprises a base 110 with sidewalls 112 which extend upwardly therefrom, defining the hollow interior region 108. Typically, within the hollow interior 108 are image capture devices (for example, cameras) 114 for capturing an image of the temperature sensors 104 and the foot in contact with the panel 102. At least one light source 116 is also optionally provided within the region 108. Said light sources may be LEDs, cathode lamps, electroluminescent coated materials and the like. Optionally, a CPU (not shown) may also be located in the hollow interior region 108 and is configured to control the operations of the device.

In some embodiments, the temperature sensors 104 may be provided on the panel 102 as printed, flexible electronic, and/or optical components. They may be printed directly onto the panel 102 or alternatively, printed onto a transparent overlay film such as Polyester or Polyethylene terephthalate glycol (PETG). Said layer may have a thickness of around 0.05 mm to 3 mm, for example. This may be subsequently attached to the transparent panel. However, it will be appreciated by those skilled in the art that the temperature sensors 104 may be provided on the panel 102 by any suitable means and comprising any suitable material and thickness. The temperature sensors 104 may be any suitable kind, such as, but not limited to, contact/non-contact sensors, Resistance Temperature Detectors (RTDs), thermocouples, thermopiles, thermistors, semiconductors, microbolometers, where an electrical property (voltage, current, resistance etc) may change with temperature. Alternatively, materials such as thermochromic liquid crystals (TLCs) may be used, wherein a visible property (such as hue, saturation, value etc.) changes with temperature.

In preferred embodiments, the temperature sensors 104 are provided on an upper side of the panel 102. This allows that the sensors 104 easily contact the region of the body under inspection (e.g., the sole of the foot).

Preferably, the sensors 104 are positioned such that the image capture devices 114 are provided with maximum visibility through the panel 102. The sensors may be connected via connection wires or traces. Preferably, the sensors 104 and connection wires are arranged to provide maximum visibility through the panel 102 to the image capture devices 114.

Typically, for TLC sensors, the change in visible property corresponding to a change in temperature may be detected optically and hence connection wires or traces are not required.

Preferably, the sensors 104 are designed to provide maximum visibility through the panel 102 to the image capture devices 114.

In an exemplary embodiment, the sensors 104 are arranged in a grid with a pitch in a range of about 0.5 cm⁻² cm, to provide adequate resolution to record the skin temperature. It is not intended to limit the present disclosure to the exemplary grid configuration described herein as a grid with alternative pitch ranges is also envisaged.

In preferred embodiments, panel 102 has sufficient strength to support the weight of an adult human.

Further, as the foot has various contours, for example the arch, the entire sole of the foot may not be in contact with the temperature sensors 104. In order to improve the contact between the temperature sensors 104 and the foot, the panel 102 may be manufactured from a flexible or resilient material that conforms to the shape of the sole of the foot. A material such as clear silicone may be used as it is both resilient and optically transparent. For example, the panel may conform to match the shape of the arch of the user's foot. This would allow more contact with the temperature sensors. In an exemplary arrangement, the panel may include one or more formations for engaging with the foot in order to enhance the area of the foot that is in contact with the temperature sensors 104. For example, the one or more formations may include one or more indentations or one or more projections or a combination of indentations and projections. It is not intended to limit the present teaching to silicone as other materials with similar properties may be used as would be understood by those skilled in the art. The temperature sensors 104 may be printed onto this layer in the same fashion as outlined above.

In preferred embodiments, panel 102 is sufficient strength to support the weight of an adult human.

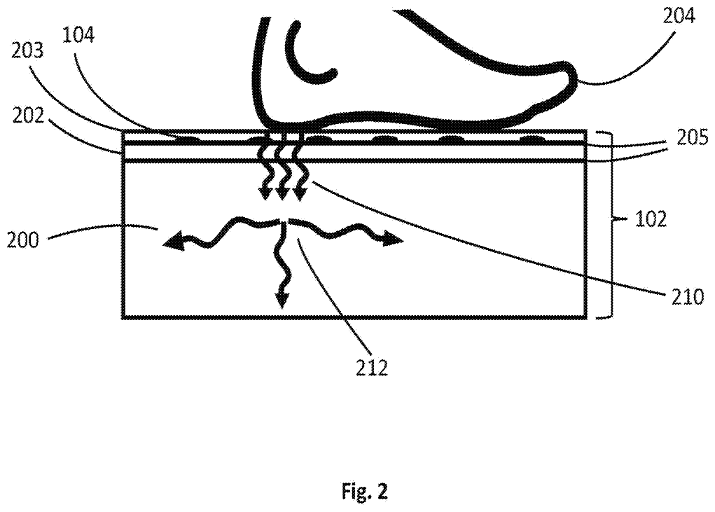

FIG. 2 shows a panel 102 (for instance, panel 102 as illustrated in FIG. 1) comprising a substrate layer 200 and a sensor layer 202. Sensor layer 202 may be in the form of an optically transparent film. The film may comprise a material such as polyester, PETG or any other suitable material. The thickness of the film may be relatively thin compared to the thickness of the substrate. The thickness of the film may be in a range of 50 μm to 3 mm. In a preferred embodiment, the temperature sensors 104 are provided on this sensor layer 202. In another embodiment the temperature sensors may be mounted directly onto the substrate 200, or in any other suitable form). The sensor layer 202 may be bonded to the substrate 200 using an adhesive layer 205. This adhesive layer is preferably an optically clear adhesive (OCA), or any other suitable material to allow visible light to pass through.

Additionally, a protective layer 203 may also be provided to protect the sensors from damage by various means such as mechanical abrasion, or contact with potentially damaging material such as water, oils, solvents, etc. The protective layer may also filter potentially harmful electromagnetic waves, for example ultraviolet (UV) light. The protective layer 203 may be bonded to the sensor layer 202 using an adhesive layer 205. Further aspects of a panel according to FIG. 2 are explained in greater detail below.

Preferably, the panel 102 is transparent such that the temperature sensors 104 and the body part under inspection (e.g., a foot) are in view to the image capture devices 114. Therefore, as described above, the substrate 200 preferably comprises a material which is both strong (such that it can support the weight of the user) and transparent or substantially transparent. Preferably, the substrate also comprises material which can act as a “chassis” or “foundation” to position and support the temperature sensors in a location which ensures sufficient thermal contact with the body part under inspection, preferably whilst providing visibility of the soles of the feet. Further, in some embodiments, e.g., where the temperature sensors may be in the form of TLCs, preferably the relative movement of the TLC sensors and the image capture devices is minimised. This is advantageous as TLC material is typically iridescent, meaning the observed visible property (e.g., hue, saturation, value etc.) is not just a function of the material temperature, but also the angle of observation and angle of illumination. Therefore, the relative movement may induce an observed change in hue in a TLC sensor which is not related to a change in temperature. The transparent panel 102 may be a rigid material such as glass; a composite; polycarbonate or other plastics material, or the like. Typically, a material suited to these criteria is glass, and preferably, tempered or thermally toughened glass. Tempered glass typically has a Young's Modulus of around 70 GPa. Glass also is of high optical transmission (>90% depending on the thickness) in the visible spectrum. Other typical properties of thermally tempered soda-lime glass are shown in Table 1 below.

TABLE 1

| | | |
|---|---|---|
| Density (p) | 2390-6190 | kg/m³ |
| Thermal conductivity (k) | 0.9-1.2 | W/m · K |
| Specific Heat (c) | 420-860 | J/Kg · K |

The following description outlines the rationale for choosing particular materials to comprise the substrate 200. Glass, and in particular, tempered glass, is a particularly suitable substrate 200 as it is readily available, has a high Young's Modulus value, and high visible transparency. Typically, tempered glass is formed by uniformly heating a glass sheet to a temperature above the glass transformation temperature, where it begins to flow. It is then rapidly cooled by air jets. The air jets cool the outer surface quickly and returns the material to its glass state. The centre of the material cools some time later, and as the volume reduces it ‘pulls’ on the now rigid outer surfaces. This pulling force causes the outer surface of the tempered glass to be compressed. The compressive force on the surface of the glass reduces crack and defect formation, giving a strong material with a Young's Modulus of approximately 70 GPa. However, other materials may be used, such as ceramics may be used which typically have a Young's Modulus of 40 GPa or above. The applied compressive force also improves the safety of the device, because if the glass is cracked, the compressive force is suddenly released, causing the panel to break into small shards which are less likely to cause bodily injury when compared to large pieces of glass.

For the purposes of illustration of the strength of the glass substrate, one may calculate the deflection of the panel (e.g., panel 102) using beam theory. This theory assumes that the panel is loaded uniformly and simply supported (e.g. supported at the ends). In practice the panel is not uniformly loaded and the panel is not supported exactly at each end, however these assumptions are to allow illustration of the general trends. The deflection (δ) of a uniformly loaded rectangular beam under a constant load is given by the Euler-Bernoulli Beam formula:

$$δ = \frac{60 q {L}^{3}}{384 E {t}^{3}}$$

Where q is the load per unit length, L is the beam width, t is the beam thickness, and E is the Young's Modulus of the material.

In preferred embodiments, the substrate 200 may be positioned below the temperature sensor layer 202, such that the sensor layer may be in direct contact with the body part under inspection. Alternatively, however, the sensor layer 202 may be positioned below the substrate 200. In such an arrangement, the substrate in turn may comprise a material which is transparent to infrared (IR) radiation, or contain openings to allow IR radiation to pass through to the sensors 104.

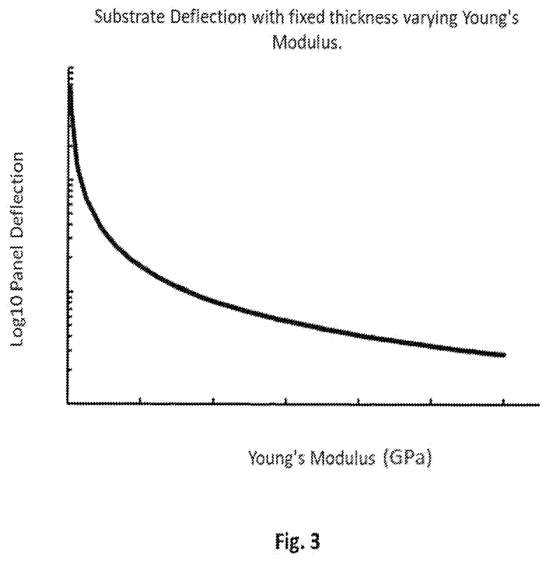

FIG. 3 is a plot of the deflection of the panel (modelled as a uniformly-loaded beam) on a logarithmic scale, with varying Young's Modulus. The inverse relationship between deflection and Young's Modulus is evident, whereby a higher Young's Modulus will result in lower deflection of the panel. Preferably, the deflection of the panel is 1 mm or less.

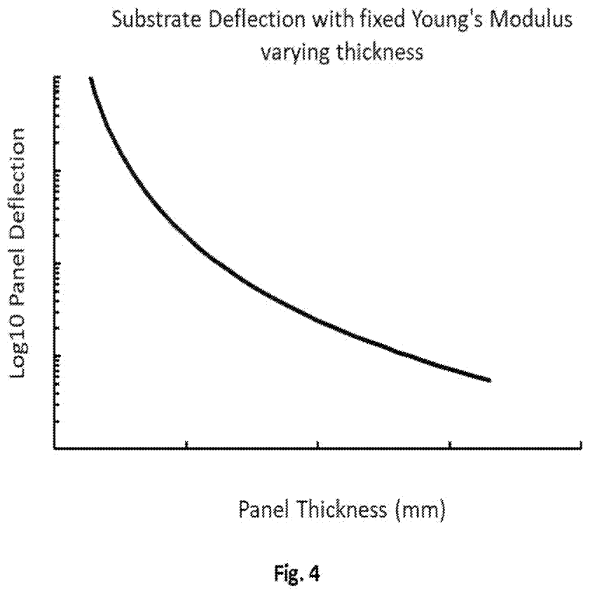

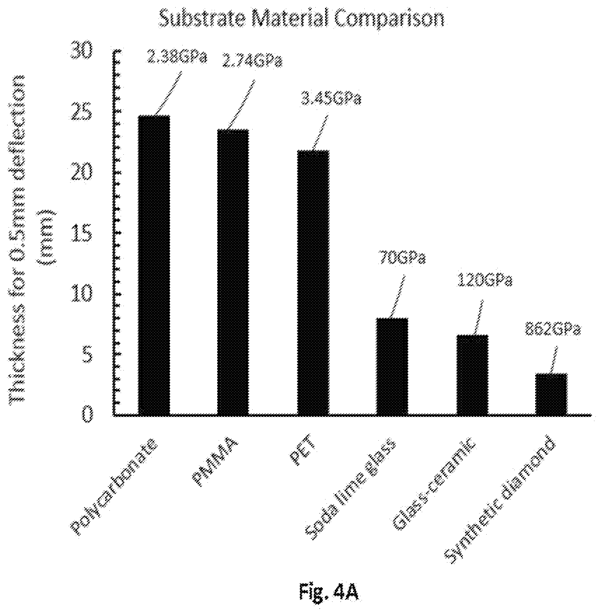

FIG. 4 is a plot of the deflection of the panel (modelled as a uniformly-loaded beam) on a logarithmic scale with varying panel thickness in millimetres, and fixed Young's Modulus. Similarly, an inverse relationship between panel thickness and deflection is evident, whereby a thicker panel will result in lower deflection. In one example, the acceptable deflection range may be around 1 mm or less. The Young's Modulus value may be around 70 GPa. However, other materials with Young's Modulus values of around 40 GPa or higher may be employed. In some examples, the substrate may be 40 cm wide and the applied load 687 N (corresponding to a 70 kg person).

FIG. 4A is a graph comparing the thickness required of a potential substrate 200 to maintain around a 0.5 mm deflection, for a 687 N uniform load and the exemplary dimensions of 40 cm in width, including the Young's Modulus of these materials. This diagram demonstrates that the transparent polymer materials, such as polycarbonate, PMMA, and PET, must have greater thicknesses (typically >20 mm) in order to deflect by the same amount as soda-lime glass, which usually requires a thickness of around 8 mm under these conditions. However, increasing the thickness of the material increases the weight (in this example, by approximately 4 kg) and height of the device, and compromises the transparency of the panel 102. Preferably, there is minimal panel deflection, as typically the imaging system has a fixed focal plane and it is preferable that the temperature sensors, and the area of skin being inspected, not deviate from this focal plane. Deflection of the sensor panel may also lead to error in the temperature reading, for example, where the temperature sensors are in the form of thermochromic liquid crystal (TLC) formations, as the observed visible properties of the TLC may be a function of viewing/illumination angle. Therefore, preferably, a rigid material such as glass is suited to this purpose.

Returning to FIG. 2, this diagram demonstrates that the temperature sensors 104 are thermally and physically connected to the substrate 200. Therefore, the temperature and thermal conductivity of the substrate 200 will affect the temperature measured by the temperature sensors 104 at the interface between panel 102 and the object 204 whose temperature is being measured. Since a glass substrate is of relatively high thermal conductivity, k, (when compared to other transparent materials) there is a large heat sink effect 212, which generates a high heat flux 210 from the object being measured 204, through the sensor layer 202 to the substrate 200. This effect is experienced frequently when in physical contact with a material of relatively high thermal conductivity, such as glass or metal, as it will feel colder to touch at ambient temperature than a material with a lower thermal conductivity such as a wood or various common plastics. Another example is tiled floors feeling colder than wooden floors, as despite being at the same ambient temperature, the higher conductivity of the tiles means they conduct the heat from the feet at a higher rate than the lower thermal conductivity wooden flooring. This results in a lower interface temperature, i.e., the tiles feel colder because the interface temperature is actually lower. This effect also impacts the sensitivity of the temperature sensors 104 at the interface to the temperature of the body part 204. When the substrate is of relatively high thermal conductivity, the absolute value of the difference between the measured temperature and the actual temperature of the body part (|(T_{Actual}−T_{Measured})|) is increased, as not only does the body part temperature influence the reading, but so too does the substrate 200 temperature and ambient temperature (which may effectively govern the substrate temperature). Further, the impact of any non-uniformity in temperature of the substrate 200 is more significant.

The present invention aims to remedy this effect by introducing a means for thermally isolating the sensors 104 from the substrate 200. In some embodiments, said means comprises an interlayer to thermally insulate the sensors from the substrate. Alternatively, the substrate 200 itself may comprise a material with thermal properties to reduce the heat flux to the substrate (e.g., a material with a lower thermal conductivity, k).

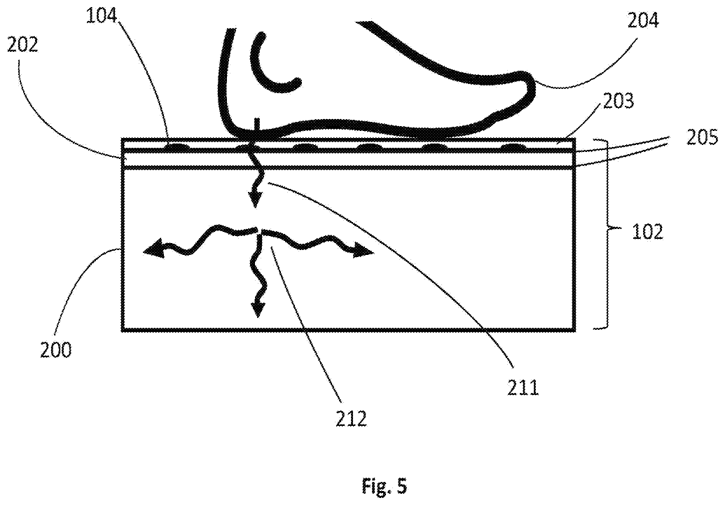

FIG. 5 is an exemplary diagram of panel 102, demonstrating the results of implementing a substrate 200 which comprises a material of suitable physical or thermal properties to reduce or prevent the heat sink effect 212. The high heat flux 210 that was seen in FIG. 2, is replaced with a low heat flux 211 from the object 204 being measured through the temperature sensor layer 202 and into the substrate 200. Typically, said substrate comprises a material with a low thermal conductivity, and preferably, a high Young's Modulus and transparency.

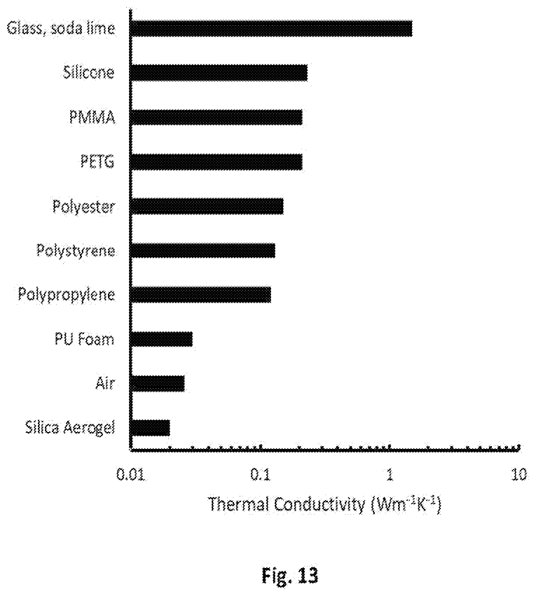

Transparent polymers such as Polycarbonate, Polymethyl methacrylate (PMMA/Acrylic) and the like may be suitable as they are transparent with low thermal conductivity. FIG. 13 provides a comparison of the thermal conductivity of these materials to others including glass. However, such materials tend to have a reduced Young's Modulus when compared with tempered glass. Therefore, in order to compensate for this effect, the substrate (comprising one or more transparent polymers) may need to be of greater thickness to provide support for the user as opposed to other materials with a higher Young's Modulus (like soda lime glass or glass ceramic). As shown in FIG. 4A, the thickness of a polymer substrate 200 would need to be two to three times that of a glass substrate to have the same level of deflection. This would result in increased assembly size, increased assembly weight, increased cost and/or reduced optical transmission.

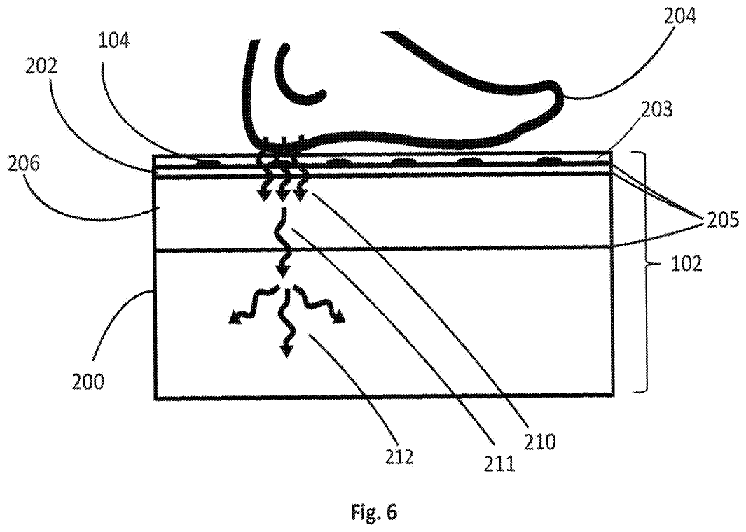

FIG. 6 is an exemplary diagram of panel 102, demonstrating the results of introducing a means for thermally isolating the sensors from the high thermal conductivity substrate 200 according to another aspect of the present disclosure. In some embodiments, said means for thermal insulation is in the form of an interlayer 206. Preferably, said interlayer 206 comprises a material of low thermal conductivity. This reduces the high heat flux 210 from the foot 204 to the sensor layer 202, to a low heat flux 211 from the sensor layer 202 to the substrate 200. This leads to the temperature sensors 104 being more sensitive to the temperature of the body part 204, as the interlayer 206 insulates the sensors 104 from the heat sink effect 212 of the high thermal conductivity substrate 200.

Advantageously, the interlayer 206 may also be made from a high optical transparency material with a low thermal conductivity such as polyester, polycarbonate, PETG or other similar materials.

The interlayer 206 may be affixed to the substrate 200 using an OCA layer 205, and the sensor layer 202 may be affixed to the interlayer in the same manner. As the interlayer 206 creates a low heat flux 211 into the substrate 200 negative the heat sink effect 212 of a high thermal conductivity substrate material, advantageously this means materials high thermal conductivity materials may be used for the substrate 200. Referring again to FIG. 4A and FIG. 13, it is seen that to achieve similar deflection, the required thickness of a glass substrate, which is of comparatively high thermal conductivity, is two to three times less than polymer materials. Thus, the presence of an interlayer 206 can significantly reduce the weight and manufacturing complexity of the panel 102.

To explore the various options for selecting a suitable interlayer material, and the influence of the interlayer on temperature measurements, the following paragraphs set out the factors relevant to the measurements to be taken by the device, and the specific physical and thermological processes which are taking place.

### Influence of Ambient Temperature

The device temperature will track the ambient temperature of the environment unless there is a sudden change ambient temperature. The small thermal mass of the device will take on the order of several hours to equalise with ambient temperature in the case that there is a sudden change (e.g. a heat source nearby to the device is activated). All elements in the device will track ambient temperature, including the glass substrate, the temperature sensors and any other layers in the sensor panel. Consequently, in the discussion in this disclosure an assumption is made that device temperature (temperature of every element in the device) is equal to ambient temperature prior to the object making contact. For clarity, when the term ambient temperature is used (T_{Ambient}), this also refers to the initial temperature of the system (device, substrate, temperature sensors) prior to the foot making contact, unless stated otherwise.

When the object under inspection makes contact with the panel 102, the sensor layer temperature will begin to change towards the temperature of the object. As the sensors 104 in this case are either directly or indirectly mated to a substrate 200, the rate of this change, and the magnitude of this change will be influenced by the thermal properties of the substrate 200.

### Forms of Heat Transfer

Exchange of thermal energy through physical systems may be in the form of conduction, convection and/or radiation. The dominant mechanism for heat transfer in the panel is usually thermal conduction. Convection occurs in liquids and gases and so is not considered for the illustrations of this example. Thermal radiation from the sensor panel is usually negligible. For example, the power output in the form of thermal radiation from a body is given by the Stefan-Boltzmann law:

$$P = εσ {AT}^{4}$$

Where P is power (measured in Js⁻¹), A is the surface area of the object (measured in m²), σ is the Stefan-Boltzmann constant (5.67×10⁸ Js⁻¹m⁻²K⁻⁴), ε is emissivity of the object (which is a measure of how well it radiates) and T is the temperature (in Kelvin). As an illustrative example, if the glass is at 35° C., with an area of 0.32 m² (where we are accounting for radiation from both sides of the glass) and of emissivity 0.9, the energy lost through radiation every second is 0.246 J. This is approximately a factor of 1000 smaller than the energy lost through conduction from the sensor layer 202 to the substrate 200 over the relevant timescales.

In construction and automotive applications, heat is usually lost by emission of IR radiation through the glass pane. Glass has a high emissivity (˜0.9) resulting in significant heat loss in a space enclosed by glass over a timescale of several hours. A transparent, metallic, low emissivity coating is applied to the glass to reduce the heat loss through radiative emission. This is known as low-emissivity or low E glass. This is distinct from the problem addressed in the present disclosure, where heat is considered to be lost typically through conduction.

### Heat Conduction Through the Interlayer

Heat flux (ϕ) from the temperature sensors into the glass substrate is governed by the heat flux equation:

$$φ ( x ) = - k \frac{dT}{dx}$$

Where k is the thermal conductivity, T is the temperature, x is the distance over which the temperature is measured, and so dT/dx is the temperature gradient across the foot and the panel. To minimise the flow of thermal energy from the sensor layer into the glass substrate, one or both parameters (k and dT/dx) is preferably minimised. The temperature gradient could be minimised by warming/cooling the panel so that it is closer to the patient's foot temp prior to use. However, the practical implementation of this may be challenging, while also requiring knowledge of the foot temperature, which is what is being measured by the device. Therefore, preferably, the thermal conductivity is reduced instead.

The actual temperature distribution across the foot and sensor panel over time can be determined by relating the heat flux with the density and specific heat capacity (the heat required to raise the temperature of a unit mass of the material by a certain amount, usually 1° C.) of the material. This is known as the heat equation:

$$\frac{\partial T}{\partial t} c ρ = - \frac{\partial φ}{\partial x} \to \frac{\partial T}{\partial t} c ρ = k \frac{\partial T}{\partial {x}^{2}}$$

Where T is the substrate temperature, c is the specific heat capacity, ρ is the material density, and k is the thermal conductivity.

### Finite Element Analysis

Analytical solutions for the heat equation exist only for some simple boundary conditions. The finite element method is a numerical method for solving partial differential equations (e.g. the heat equation) which would otherwise be difficult, if not impossible, to solve analytically. To calculate the temperature distribution occurring in the sensor panel when in use, an exemplary 1D Finite Element (FE) model was developed. This allows impact of changes to the thickness and thermal properties of the interlayer on the sensor layer temperature to be deduced.

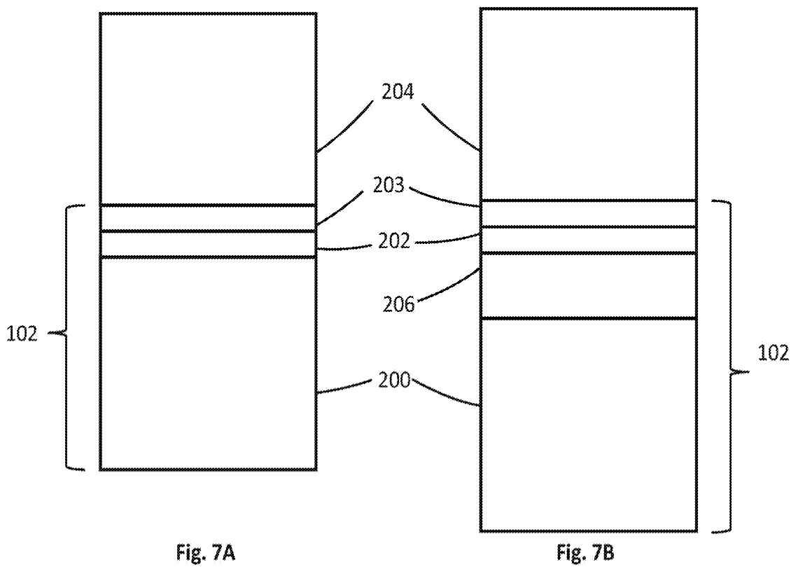

FIGS. 7A and 7B are exemplary diagrams of a 1D model of the panel 102 and foot 204, to illustrate the effects of adjusting the parameters or characteristics of the interlayer material 206 on the temperature of the sensor layer 202. FIG. 7A is a diagram of the panel 102 with no interlayer 206 present. FIG. 7B is an exemplary diagram of the panel with an interlayer 206 present. From the heat equation outlined above, the relevant parameters may include any of the following: the thermal conductivity (k), material density (ρ), and specific heat capacity (c). In this exemplary simulation, the foot layer was set at 5 mm thick. In this example, the thickness of the foot layer is much greater than the thickness of the other layers, and the inventors found that the absolute value of the thickness had negligible impact on the result. A heating term was also included in the foot layer to simulate heating of the foot due to blood flow. In some embodiments, the top surface of the sensor layer 202 may be protected, e.g., from abrasion, by any suitable means, for example, by means of a protective layer 203 of any appropriate material. In this exemplary model, the thickness of the sensor layer 202 and protective layer 203 are each around 0.1 mm. The thickness of the substrate 200 in this exemplary model is around 8 mm. Adhesive layers in the sensor panel are ignored in this exemplary model, as their small thickness (typically around 0.1 mm) relative to the other layers means their material properties have a negligible effect on the temperature distribution. The temperature at the top of the sensor layer was calculated. The skilled person will appreciate that the examples given for this model and the structure of FIGS. 7A and 7B is for illustrative purposes only, and are not intended to limit the scope of the disclosure.

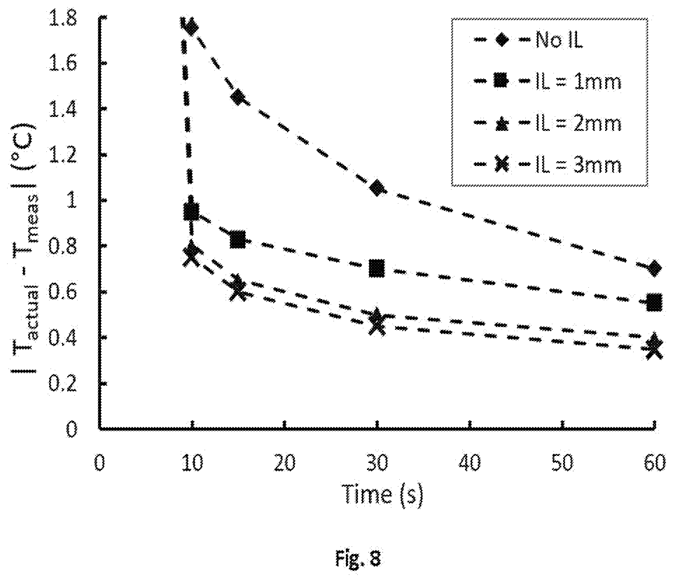

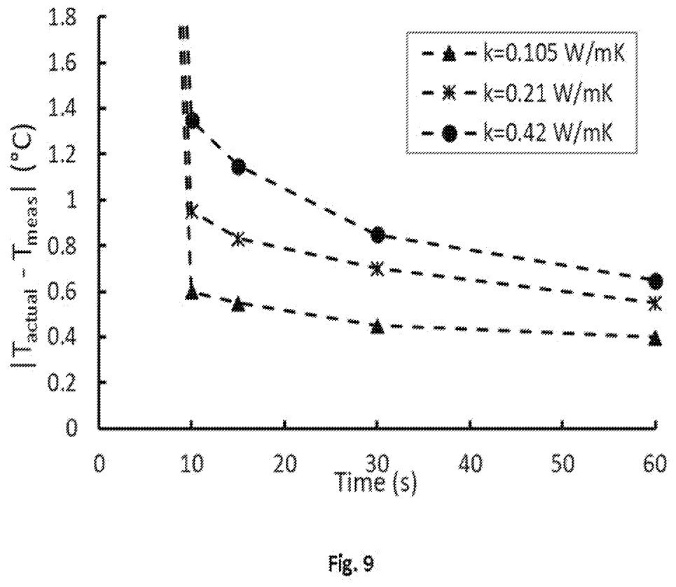

The heat equation was solved for time intervals up to 60 seconds. The material parameters (excluding the foot layer 204) were varied systematically to identify the relationship between the material parameters and the temperature in the sensor layer 202. The results of the FE analysis of the temperature of the sensor layer 202 are described with reference to FIG. 8 and FIG. 9. Throughout this disclosure, the actual temperature of the body part under inspection is denoted interchangeably by “T_{Actual}”, “T_{actual}”, “TActual” etc., and the measured temperature of the body part under inspection is denoted interchangeably by “T_{Measured}”, “Tₘₑₐₛ”, “T_{measured}”, “TMeasured” etc. The skilled person will understand that these different labels do not confer different meanings unless stated otherwise. For both plots of exemplary FIG. 8 and exemplary FIG. 9, the actual foot initial temperature is 30° C., the sensor panel initial temperature is 20° C., the interlayer density is 1270 kg/m³, the interlayer specific heat capacity is 1300 JKg⁻¹K⁻¹. However, these values are used for illustrative purposes only and are not intended to limit the scope of the disclosure.

FIG. 8 is an exemplary plot of the difference between the true temperature of the foot (T_{Actual}) and the temperature of the foot measured by the temperature sensors 104 (T_{Measured}), the sensors 104 comprising the sensor layer 202, with varying thicknesses of interlayer “IL” 206, from no interlayer to an interlayer thickness of around 3 mm. The change in this temperature difference (|T_{Actual}−T_{Measured}|) is shown over time for each interlayer thickness. It is clear from FIG. 8 that the presence of an interlayer, and increasing the thickness of said interlayer (from 1 to 3 mm) reduces the difference between T_{Actual} and T_{Measured}, where T_{Actual} in this example is 30° C. The thickness of the interlayer may take any suitable dimension. The FE simulation further showed that the benefit of increasing interlayer thickness (in reducing the T_{Actual}−T_{Measured}) plateaus at around 2 mm. The plot shown is for 1 mm, 2 mm, and a 3 mm thickness interlayer 206, but the skilled person will appreciate that these values are for exemplary purposes and are this is not intended to limit the scope of the present disclosure.

FIG. 9 is an exemplary plot outlining the results of the FE analysis of the temperature of the sensor layer 202 over time for decreasing values of thermal conductivity, k. This plot demonstrates that decreasing the thermal conductivity of the interlayer 206 results in a decreased value for T_{Actual}−T_{Measured} (i.e., the temperature readings become increasingly accurate). The conductivity values, k, used here are provided by way of example only, and are not intended to limit the scope of the present disclosure. Furthermore, while the model used for the FE analysis incorporated an interlayer, the skilled person will appreciate that other embodiments may incorporate a suitable material (of appropriate values of thermal conductivity, thickness, transparency etc.) which may act as both a substrate 200 for the components of the panel, and a means of preventing undesirable thermal effects within the panel.

While not explicitly shown in the Figures, it was found that the density and the specific heat capacity of the interlayer material also have an effect. Decreasing the density of the material reduced the difference T_{Actual}−T_{Measured}. Decreasing the specific heat capacity, c, was also found to reduce the difference T_{Actual}−T_{Measured}. Optionally therefore, a material comprising the insulating layer (e.g., the interlayer or substrate) may comprise a material with either or both of these properties. However, the dependency of the error (or T_{Actual}−T_{Measured}) on either of these parameters was found to be less notable than the dependency on thickness/thermal conductivity.

FIGS. 8 and 9, respectively, illustrate that increasing interlayer thickness and decreasing interlayer k will reduce the value of (T_{Actual}−T_{Measured}), as the interlayer is achieving the desired effect of suppressing the heat sink effect of the high thermal conductivity (e.g., glass) substrate 202. This, in turn, improves the signal-to-noise ratio (see below for more detail).

Another factor of interest is the time taken for the sensor layer 202 to reach an acceptable level of thermal equilibrium, whereby the rate of change of the sensor temperature with time (dT/dt) is within an acceptable range. In preferred embodiments, the range of dT/dt may be around 0.2° C./s or lower. Further, the rate of change in sensor temperature may be related to the scan time, which is the time required to read from all temperature sensors 104. The more quickly the panel reaches thermal equilibrium, the more quickly the measurement may be completed. A shorter scan time may mean a higher acceptable dT/dt value. For example, the acceptable threshold of dT/dt for a 5 s scan time may be 0.2° C./s, and for a 10 s scan time this may be 0.1° C./s. It is desirable to minimise the wait time for the user. Incorporating an interlayer 206 into the panel assembly reduces this wait time by reducing the time it takes to reach thermal equilibrium. This effect is shown in FIG. 8, where it is evident that the presence of an interlayer, and increasing the thickness of said interlayer, reduces the time taken for the panel to reach thermal equilibrium (i.e., the point where the temperature difference T_{Actual}−T_{Measured} stays constant), as shown by the steeper slope with increased interlayer thickness. FIG. 9 demonstrates that decreasing the thermal conductivity, k, of the interlayer 206, also reduces the amount of time taken to reach thermal equilibrium, as shown by a steeper slope with decreased thermal conductivity.

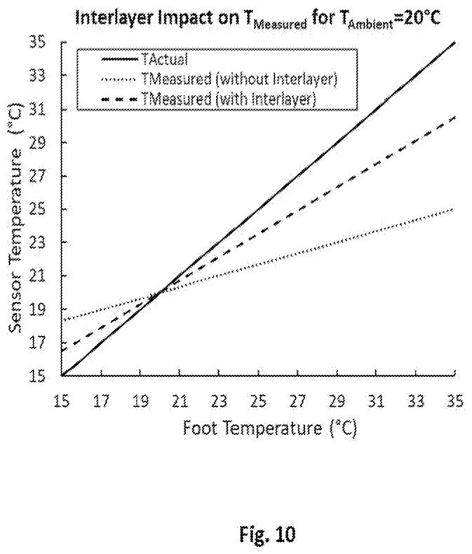

FIG. 10 is a plot showing the relationship between the measured temperature (T_{Measured}) and actual foot temperature (T_{Actual}) with and without the presence of an interlayer. The graph shows the results at a fixed time t=15 s, for a fixed interlayer thermal conductivity value and fixed interlayer thickness. In this plot, the foot temperature is varied while the temperature of the ambient environment in which the assembly is placed, denoted by T_{Ambient}, is kept constant at 20° C. The substrate 200 temperature onto which the sensor layer is typically mounted may track ambient temperature. It can be seen that the presence of the interlayer reduces the difference between the foot temperature and the sensor layer temperature as foot temperature is varied. For large differences (e.g. >20° C.) between the T_{Ambient} and the foot temperature, the plot of T_{Measured} may become non-linear. This figure plots only the temperature range relevant to human foot temperature inspections. Prior to performing a temperature measurement of the user's foot, the temperature of the sensor panel may be measured to ensure that it is within an operating temperature range, or the range that gives a linear relationship between T_{Actual} and T_{Measured}. This operating temperature range may be 10-40° C.

Table A reiterates the data in FIG. 10 and the beneficial effect of the interlayer. The table shows that T_{Measured} more closely matches T_{Actual} with the presence of an interlayer.

TABLE A
Impact of Interlayer on T_{Measured} for
fixed T_{Ambient} and varying T_{Actual}

| | | T_{Measured} with | T_{Measured} without |
|---|---|---|---|
| T_{Ambient} | T_{Actual} | Interlayer | Interlayer |
| (° C.) | (° C.) | (° C.) | (° C.) |
| 20 | 18 | 18.6 | 19.2 |
| 20 | 19 | 19.7 | 19.6 |
| 20 | 20 | 20.0 | 20.0 |
| 20 | 21 | 20.7 | 20.4 |
| 20 | 22 | 21.4 | 20.8 |

Further to this analysis, Table B demonstrates the effect of changing T_{Ambient}on T_{Measured}. The table shows that T_{Measured} is dependent T_{Ambient}, in that a higher ambient temperature results in a higher measured foot temperature. As with the results in Table A the inclusion of an interlayer reduced the difference between T_{Actual} and T_{Measured}.

TABLE B
Impact of Interlayer on T_{Measured} for
varying T_{Ambient} and fixed T_{Actual}

| | | T_{measured} with | T_{Measured} without |
|---|---|---|---|
| T_{Ambient} | T_{Actual} | Interlayer | Interlayer |
| (° C.) | (° C.) | (° C.) | (° C.) |
| 18 | 20 | 18.7 | 18.2 |
| 19 | 20 | 19.3 | 19.1 |
| 20 | 20 | 20.0 | 20.0 |
| 21 | 20 | 20.7 | 20.9 |
| 22 | 20 | 21.3 | 21.8 |

Together, Table A and Table B indicate that, in order to accurately determine T_{Actual} from T_{Measured}, knowledge of (i) the sensor panel thermal properties and/or (ii) ambient temperature may be required.

### Signal-To-Noise ratio for Temperature Asymmetry Monitoring

As mentioned, the temperature sensors used in the present disclosure may be in any suitable form, such as thermocouples (which result in a change in voltage with temperature), thermistors (a change in resistance with temperature) and IR thermometers (the wavelength of emitted IR radiation is indicative of the temperature). In some embodiments, TLCs comprise the temperature sensors 104. These may change colour (hue) in accordance with the change in temperature. This is advantageous, as an image of both the body part under inspection (the foot/feet) and the temperature data may be captured. However, as highlighted above, the temperature sensors are affected by the thermal conduction to adjacent layers (e.g., the substrate 200).

All measurements have some degree of error, noise, and uncertainty due to various sources such as bias, drift, repeatability, resolution, accuracy of calibration etc. One of the measurements of interest in respect of the present disclosure is the difference in temperature between body parts (e.g., between corresponding locations on the two feet of a user). This is to compare the temperature at points along the soles of the feet and deduce if there are any temperature anomalies, which may indicate that a skin abnormality is present or forming. In the following discussion, the measured temperature difference between the user's feet is denoted as ΔT_{Measured}, and the actual temperature difference between the user's two feet is denoted as ΔT_{Actual}.

With increased error, the result is a lower signal-to-noise ratio (SNR), as the measured temperature at the sensor layer 202 is different to the temperature of the actual foot. If ΔT_{Measured} is the measured difference in temperature between the feet, then the signal-to-noise ratio may be written as:

$$S N R = \frac{Δ {T}_{measured}}{Measurement Noise}$$

To maximise the SNR, preferably, ΔT_{Measured} should be maximised while measurement noise should be minimised. Addition of an interlayer will contribute towards both of these targets. Consider the following example, where the noise has been set to ±0.5° C. In this example, the actual, or true, temperature difference between the feet of a user is 3° C. (ΔT_{actual}=3° C.). To maximise the SNR, the measured temperature difference between the two feet (ΔT_{Measured}), should be as close to ΔT_{actual} (in this example, 3° C.) as possible. The thermal properties of the substrate 200 (and, if present, interlayer 206) influence the measured temperature difference, and therefore influence the SNR. For instance, in a case where one foot is at 20° C. (same temperature as the substrate) and the other is at 23° C., ideally, ΔT_{Measured} will be 3° C., giving an SNR of 6. In practice the ΔT_{Measured} will be impacted by thermal conduction from the sensor layer 202 into e.g., the glass panel (which may comprise the substrate 200). In other words, more thermal energy will be transferred from the other foot (of actual temperature of 23° C.) to the adjacent layer (e.g., substrate 200 or interlayer 206) with a greater thermal conductivity, such that the foot appears to be lower in temperature. This means that T_{Measured} may read as less than 3° C., and a skin abnormality may not be flagged.

Using the FE analysis, the improvement in SNR with the inclusion of an interlayer may be demonstrated. Table C is a table of results of this analysis. In the exemplary model, the measured temperature, T_{Measured}, for each foot was calculated for a fixed ambient temperature, T_{Ambient}, of 20° C., for an interlayer 206 of fixed thickness of around 1 mm and having a fixed thermal conductivity of around 0.21 W/mK, at a fixed time of t=15 seconds. The temperature was measured for various actual foot temperatures, both with an interlayer present (denoted by “Yes” in the first column) and with no interlayer present (denoted by “No” in the first column).

For each of the three actual foot temperatures, the actual temperature difference (ΔT_{Actual}) between the left foot and right foot is 2.2° C. The corresponding measured temperatures of each foot, T_{Measured}, were used to calculate the measured temperature difference, ΔT_{Measured}, between the left foot and right foot.

The final column indicates the SNR value for a fixed level of measurement error, which in this example is 0.5° C. With no interlayer present, the value of ΔT_{Measured} was found to be 0.75° C. for ΔT_{Actual} of 2.2° C., and a corresponding SNR of 1.5. However, with the presence of an interlayer, the value of ΔT_{Measured} was found to be 1.76° C., which is much closer to the true temperature difference value ΔT_{Actual} of 2.2° C. This results in an SNR of 3.5.

TABLE C
Impact of Interlayer on SNR for fixed ΔT_{Actual}

| | | Right | Left | | Right | Left | | |
|---|---|---|---|---|---|---|---|---|
| Interlayer | | Foot | Foot | | Foot | Foot | | |
| Present | T_{Ambient} | T_{Actual} | T_{Actual} | ΔT_{Actual} | T_{Measured} | T_{Measured} | ΔT_{Measured} | |
| (Y/N) | (° C.) | (° C.) | (° C.) | (° C.) | (° C.) | (° C.) | (° C.) | SNR |
| No | 20 | 20 | 22.2 | 2.2 | 20 | 20.75 | 0.75 | 1.5 |
| | | 23 | 25.2 | | 21 | 21.75 | | |
| | | 25 | 27.2 | | 21.67 | 22.41 | | |
| Yes | 20 | 20 | 22.2 | 2.2 | 20 | 21.76 | 1.76 | 3.5 |
| | | 23 | 25.2 | | 22.15 | 23.91 | | |
| | | 25 | 27.2 | | 23.59 | 25.35 | | |

The measured temperature difference ΔT_{Measured} and measurement noise may also depend on any temperature gradients present in the panel prior to the measurement being taken. For example, if the assembly is left next to a heat source, it may be warmer on one side. Therefore, it is preferable to select a suitable interlayer 206, or to select a suitable substrate 200 material, to reduce the measurement noise caused by temperature gradients and maximise the SNR. With the incorporation of a suitable thermally-insulating mechanism, e.g., an interlayer, for a fixed level of noise, the SNR is improved, yielding more accurate temperature readings. The temperature gradient across the panel may be measured by one or more internal, and/or external, temperature probes in and/or on the device prior to use to ensure there are no significant temperature gradients present. These temperature probes may take any suitable form, and may be distributed throughout a layer of the panel, at discrete regular points, or otherwise, to measure the temperature gradient. For example, four temperature probes may be placed in each corner of the assembly, to monitor for temperature gradients across the sensor panel.

Further, in some exemplary embodiments, the skin inspection assembly may be configured to prevent temperature measurements if the ambient and/or substrate temperature is not within a predetermined threshold. For instance, if the device has been placed in an environment where it is subject to temperatures outside a certain range, the readings may be less accurate. Thus, the assembly may comprise means by which to measure the ambient temperature and/or substrate temperature, and prevent temperature measurement of the object of interest (e.g., a foot) in the case where the ambient temperature is outside an acceptable range. This acceptable range may be set at 15 to 35° C., 10 to 40° C. or 0-50° C. etc. The substrate and/or ambient temperature sensing means may comprise any suitable temperature sensor, and may, for example, comprise the temperature probes described in the preceding paragraph.

### Temperature Asymmetry Monitoring and Determining Equivalent Temperature Inspection Thresholds

As discussed, by quantifying the thermal properties of the system, one can establish the relationship between T_{Actual} and T_{Measured} at a given T_{Ambient} and it is possible to use a model to correlate the temperature measured by a sensor (T_{Measured}) to the temperature of the object prior to making contact with the system (T_{Actual}). To solve for T_{Actual} of each foot prior to making contact, an input may be T_{Ambient}. T_{Ambient} may be the temperature of the substrate prior to the object (e.g., foot) coming into contact with it, which may be the case for any such system where temperature sensors comprise the substrate 200 or other component of the assembly, and track T_{Ambient}. However, as shown in Table D, determining ΔT_{Measured} between two locations is independent of the equivalent temperature difference between two locations is independent of the device initial temperature.

The results of the exemplary FE analysis presented in Table D are shown where T_{Measured} for both feet are calculated for a fixed time (t=15 s), fixed interlayer thickness (1 mm) and fixed thermal conductivity (0.21 W/mK). Here T_{Actual} left foot and T_{Actual} right foot are fixed at 22.2° C. and 20° C. respectively. T_{Ambient} is varied and ΔT_{Measured} is calculated for each case.

TABLE D
ΔT_{Measured} is fixed for a fixed ΔT_{Actual} and varying T_{Ambient}

| | Right Foot | Left Foot | | Right foot | Left foot | |
|---|---|---|---|---|---|---|
| T_{Ambient} | T_{Actual} | T_{Actual} | ΔT_{Actual} | T_{Measured} | T_{Measured} | ΔT_{Measured} |
| (° C.) | (° C.) | (° C.) | (° C.) | (° C.) | (° C.) | (° C.) |
| 20 | 20 | 22.2 | 2.2 | 20.00 | 21.76 | 1.76 |
| 23 | 20 | 22.2 | 2.2 | 20.80 | 22.56 | 1.76 |
| 25 | 20 | 22.2 | 2.2 | 21.50 | 23.26 | 1.76 |

A key observation is that ΔT_{Measured} is independent of ambient temperature T_{Ambient}. This means that by characterising the thermal response of the panel, i.e., characterising the measured temperature corresponding to the actual temperature, it is possible to establish an “inspection threshold” for ΔT_{Measured} that is equivalent to a specified inspection threshold for ΔT_{Actual}. For the example shown in Table D, a ΔT_{Measured} inspection threshold of 1.76° C. is equivalent to a ΔT_{Actual} inspection threshold of 2.2° C. Table C shows another example where the thermal properties of the assembly are varied by the removal of the interlayer, a ΔT_{Measured} inspection threshold of 0.75° C. is equivalent to a ΔT_{Actual} inspection threshold of 2.2° C.

Finally, Table E is an exemplary table showing the results of the FE analysis for the case where T_{Ambient} is fixed and the T_{Actual} for each foot is varied, while ΔT_{Actual} remains fixed at 2.2° C. Other parameters are similar to previous simulations: both feet are calculated for a fixed time (t=15 s), fixed interlayer thickness (1 mm) and fixed thermal conductivity (0.21 W/mK). This analysis shows that the value for ΔT_{Measured} does not depend on the absolute temperature of each foot but rather depends only on ΔT_{Actual}.

TABLE E
ΔT_{Measured} is fixed for a varying T_{Actual} with fixed ΔT_{Actual}, and fixed T_{Ambient}

| | Right Foot | Left Foot | | Right foot | Left foot | |
|---|---|---|---|---|---|---|
| T_{Ambient} | T_{Actual} | T_{Actual} | ΔT_{Actual} | T_{Measured} | T_{Measured} | ΔT_{Measured} |
| (° C.) | (° C.) | (° C.) | (° C.) | (° C.) | (° C.) | (° C.) |
| 20 | 20 | 22.2 | 2.2 | 20.00 | 21.76 | 1.76 |
| 20 | 23 | 25.2 | 2.2 | 22.15 | 23.91 | 1.76 |
| 20 | 25 | 27.2 | 2.2 | 23.59 | 25.35 | 1.76 |

These effects are of benefit for performing temperature asymmetry monitoring, as there is no need to measure T_{Ambient}, and convert measured temperatures (T_{Measured}) to the pre-contact temperature (T_{Actual}), but instead the measured temperature difference (ΔT_{Measured}) may be assessed against the equivalent inspection threshold that would be applied to actual temperature difference measurements (ΔT_{Actual}). This is advantageous for several reasons: it removes a source of noise (the measurement of T_{Ambient}); it reduces the cost of additional sensors to measure T_{Ambien}t; and in the case where many temperature sensors are being sampled, it saves computational time. This effect also removes the need to control the device temperature to be within a certain range through heating or cooling of the device.

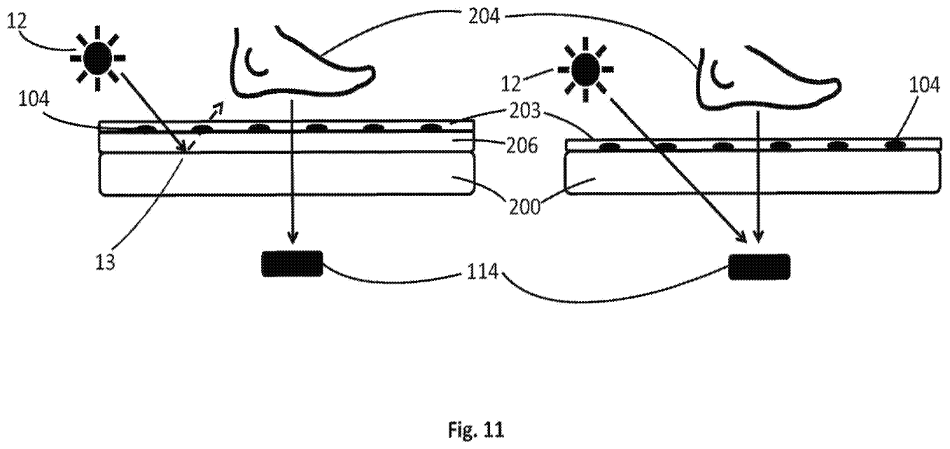

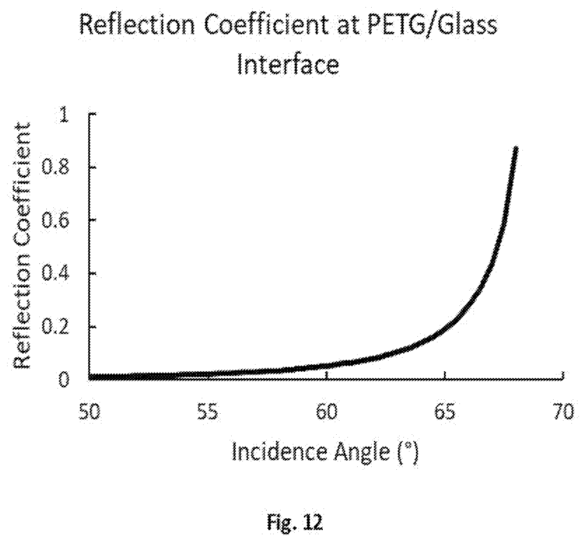

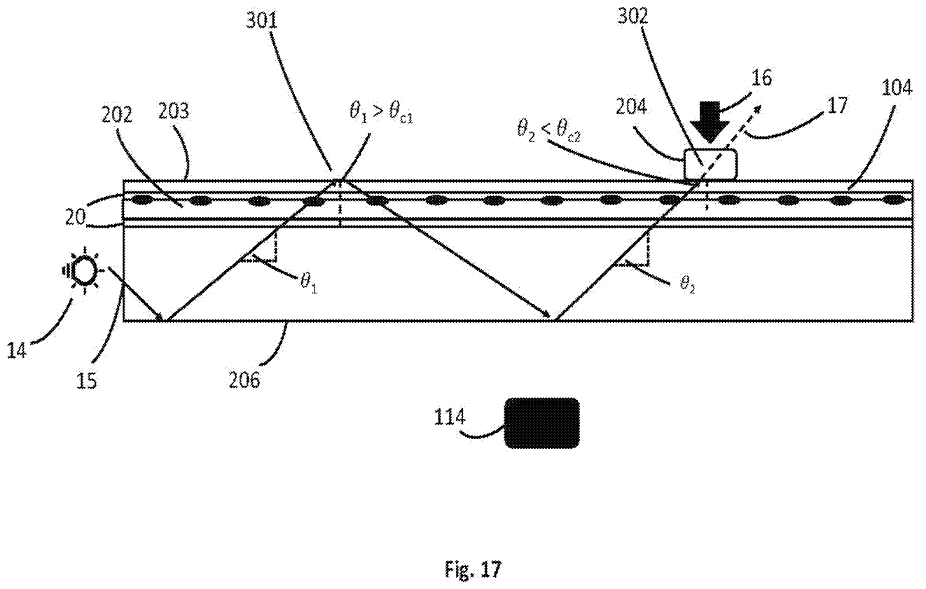

FIG. 11 is an exemplary diagram illustrating the effects of an interlayer 206 on the amount of light incident on the panel 102. This demonstrates another how an interlayer 206 with a higher refractive index than the substrate 200 will reflect light away if the incident angle of the ambient light noise 12 is greater than the critical angle for total internal reflection (TIR) 13. As explained in more detail with reference to FIG. 17, TIR occurs where waves (e.g., light waves) arriving at the interface between one medium and another are not refracted into the second medium, but are completely reflected back into the first (“internal”) medium, which happens when light is incident at the interface at an angle greater than or equal to the “critical angle”. An interlayer 206 material, for example, a transparent polymer with a high refractive index (˜1.8), on top of a glass substrate 200, would be opaque to light which is incident at angles greater than 50°. This has the advantage of reducing the amount of background light (e.g., sunlight, room lighting etc.) 12 incident on the image capture device(s) 114 contained in the housing 106 (not shown), while maintaining the quality of the image. This can increase the SNR. For instance, PETG has a refractive index of about 1.57. Further, there is a potential to use transparent polymer films of refractive index 1.9, which have been formed from elemental sulfur. Said means may be placed atop the interlayer 206 or on other layers of the panel 102, or may comprise one or more of the layers of the panel 102 such that this forms a composite. FIG. 12 is a plot of reflection coefficient versus angle of incidence, exemplifying the effect at a PETG and soda-lime glass interface.

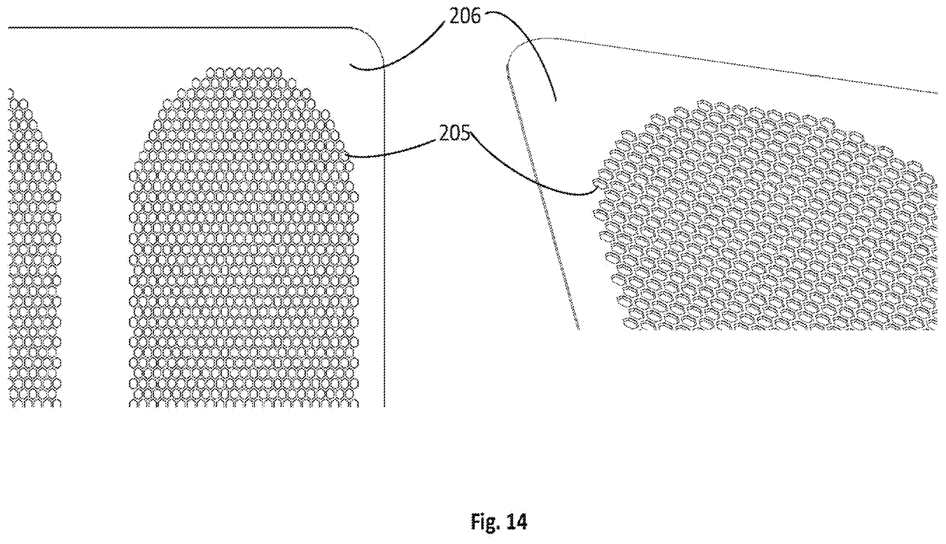

FIG. 13 is an exemplary diagram of different transparent materials, and the value of the thermal conductivity for each material. This figure teaches the thermal conductivity of the possible transparent materials that are available for use in the substrate or interlayer. FIG. 13 shows that silica aerogel is most suitable as an insulating material due to its low thermal conductivity. However, usually it is not sufficiently transparent nor is it widely available, and so is not optimal in scenarios where increased availability and cost-effectiveness are desirable factors. Of these materials, air is the next most effective insulating material. Therefore, it may be possible to implement an air gap as an interlayer 206 in the panel 102, which is described below in reference to FIG. 14. Polyurethane (PU) foams are available in translucent forms, but rarely with the required transparency for the sensor panel 102. The remaining transparent polymers (polystyrene, polypropylene, polyester, PETG, PMMA) offer similar thermal performance. Therefore, the choice of interlayer material depends on any combination of the factors of thermal performance, transparency, cost and ease of integration into the sensor panel stack. PETG was chosen for the purposes of the illustrated embodiments due to its wide availability and optical properties.

The following description outlines exemplary methods for incorporating the interlayer 206 into the panel 102. In some embodiments, the interlayer 206 may be affixed to the substrate 200 through any suitable means, such as mechanical fixations (e.g., screws, tab, frames, and the like). In other embodiments, the interlayer 206 may be bonded to the substrate 200 through any suitable adhesive and/or lamination techniques. Some example adhesives include liquid-based adhesives such as Cyanoacrylates, acrylics. These may cure by various means including self-curing, pressure-curing, thermal-curing, or via UV light exposure. Alternatively, film-based adhesives may also be used, often referred to as Optically Clear Adhesive (OCA) films. Other means of bonding the interlayer 206 to the substrate 200 is through the use of an autoclave (for instance, such as that used for the production of laminated glass).

In alternative embodiments, such as those in which the interlayer 206 comprises an air gap, spacers may be used between the substrate 200 and sensor layer 202. For example, the spacers may take the form of a honeycomb sheet, where at least one of the openings correspond to the locations of the temperature sensors such that they are visible to the image capture device(s). In this manner, the load-bearing and optical transmission properties are maintained. FIG. 14 is an exemplary diagram of such an arrangement, where the honeycomb sheet forms openings 205 around the areas where the user's feet are to be placed, but may partially or completely take up the entire interlayer 206. It will be appreciated by the skilled person in the art that an air gap may be implemented by any other suitable means, such as another kind of mesh or matrix. Alternatively, the structure which forms the air gap may comprise the substrate 200 without requirement for an interlayer 206. For instance, the glass substrate 200 may comprise the honeycomb structure, rather than an interlayer 206.

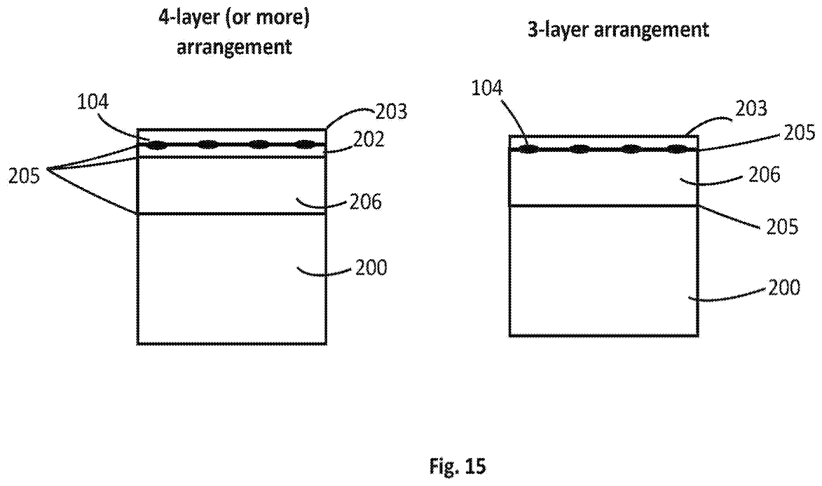

FIG. 15 is an exemplary diagram of cross sections of possible configurations of the panel 102 of assembly 100 (which typically comprises the panel 102 and housing 106). In some embodiments, the panel 102 may comprise four or more layers, comprising a protective layer 203, sensor layer 202, interlayer 206, and substrate 200. In this example, the substrate 200 comprises thermally toughened glass, which may be 8 mm thick, or may comprise soda lime silicate glass of 8 mm thickness, or any other suitable material and thickness. The adhesive in this example, by which the interlayer 206 is bonded to the substrate 200, may comprise an OCA layer 205. However, the interlayer 206 may be bonded to substrate 200 by any suitable means, such as by thermal bonding. In this exemplary embodiment, the OCA layer 205 is an acrylic adhesive of 50 μm thickness. Alternative thicknesses for the OCA layer 205 may also be used, such as 10 μm, 25 μm or 0.1 mm, or any value in between. In this example, the interlayer 206 material comprises PETG of suitable thickness. For instance, the PETG may be around 1 mm thick. Alternative thicknesses for the interlayer may also be used such as 0.2 mm, 0.5 mm for example, or thicker such as 1.5 mm or 3 mm, or any value in between. Here, the interlayer 206 may be laminated onto the substrate 200. In this exemplary embodiment, the sensor layer 202 comprises TLC formations as temperature sensors 104. However, the sensors may take any other suitable form. The TLC sensors may be printed onto a polyester surface by any suitable means. In this exemplary embodiment, the polyester surface is in turn laminated to the top surface of interlayer 206 by means of an adhesive. In this example, the adhesive comprises an OCA, which may be any suitable material, such as acrylic adhesive. The acrylic adhesive used here may be about 50 μm thick. In some embodiments, the top surface of the sensor layer 202 may be protected, from abrasion etc., by any suitable means. In the example, the protective means is in the form of a sheet of polyester protective layer 203. Preferably, the thickness of the protective layer 203 is sufficient to provide protection of the underlying layer of the panel 102, while simultaneously being as thin to minimise the insulation of the sensors 104 from the object 204 being measured. The protective layer may be affixed by lamination, or any other suitable means. In some embodiments, the protective layer 203 comprises a layer of polyester (which may be, for example 125 μm thick) laminated to the sensor layer 202 using a layer of OCA (which may be 50 μm thick), for example. In other embodiments, the protective layer 203 may itself comprise a layer of OCA, which may be 50 μm. These values are merely for illustrative purposes only, and the skilled person will appreciate that any suitable thickness for these layers may be used. However, these examples are described by way of illustration only, and the skilled person will appreciate that other suitable protective and adhesive means may be employed.

In another embodiment shown in FIG. 15, the panel 102 may comprise three layers—a protective layer 202, interlayer 206, and substrate 200. In this embodiment the interlayer 206 in turn comprises the sensor layer 202. In other words, the interlayer 206 may also act as the sensor layer 202 as it may comprise the temperature sensors 104. For instance, whereby the temperature sensors 104 are printed, or otherwise, onto the interlayer 206.

Depending on the assembly employed, the appropriate materials and dimensions may be chosen. In preferred embodiments, the panel 102 comprises a material with sufficient thickness, thermal conductivity, and Young's Modulus such that accurate temperature readings and visual examination may be carried out while supporting the weight of a user with minimal deflection. Preferably, said readings and examination are carried out during a minimal wait time for the user.

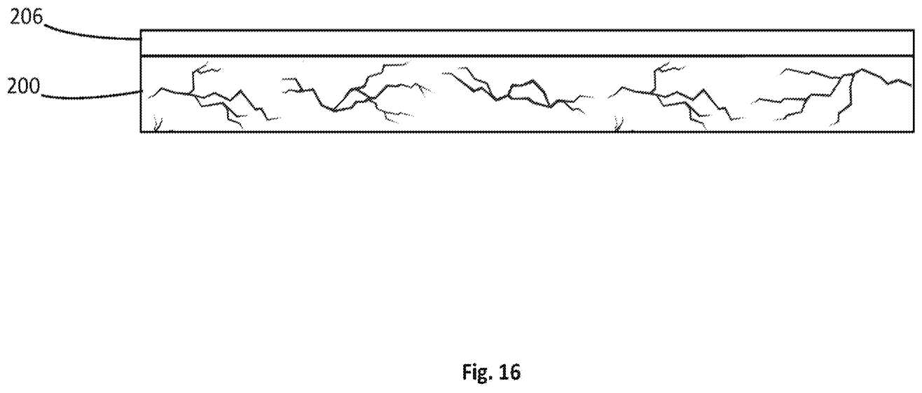

A further advantage of the interlayer concerns safety aspects related to the use of glass, or any other brittle material, as the substrate material. The interlayer 206 will act to bind the pieces together should the substrate 200 break. Tempered glass will break into small shards due to the compressive stress in the material. These features combined minimises risk of injury to the user. FIG. 16 exemplifies that if the substrate 200 breaks, perhaps if the substrate 200 is made of brittle material, the interlayer 206 keeps the fragments of the substrate 200 together. Therefore, the interlayer 206 may provide a safety mechanism which prevents shards of material penetrating the sole of a foot under inspection if the substrate 200 shatters or cracks.

Advantageously, depending on the material chosen for the interlayer 206 and the arrangement of the panel 102 employed, the electrical insulation provided by the panel may be improved with the presence of an interlayer 206 or suitable substrate 200 material. Further, the coefficient of friction tends to be higher for polymers than for materials such as glass, which enhances the safety of the apparatus as it prevents slipping, particularly if the surface is wet.

In other embodiments, the assembly may incorporate a pressure-sensitive means. In preferred embodiments, the pressure-sensitive means may comprise a pressure-sensitive layer. In other embodiments, said layer may comprise a pressure-sensitive material, for example pressure-sensitive and perhaps, temperature-insensitive TLCs. The change in hue of the pressure-sensitive TLCs with pressure can be measured by the camera. In alternative embodiments, the pressure-sensitive mechanism may comprise a pressure-sensitive resistor which may have a variable resistance based on applied pressure. Such sensors could be arranged in a grid pattern and read-out using a microcontroller.

In embodiments which comprise a pressure-sensitive layer, visible light may be coupled into the one or more of the layers in the panel 102, for example the interlayer 206, or another layer of the panel 102, as shown in FIG. 17. In said exemplary embodiment, light from a light source 14 is “injected” into the interlayer 206, as the light is edge-coupled, denoted by reference numeral 15, to the interlayer 206. FIG. 17 shows that the light cannot escape the panel due to total internal reflection, denoted by reference numeral 301. This is when light waves arriving at the interface between one medium and another are not refracted into the second medium, but are completely reflected back into the first (“internal”) medium. This occurs when light is incident at the interface at an angle greater than or equal to the “critical angle”. In this case, the first medium (of refractive index n₁) may comprise the panel 102, which may in turn comprise the substrate 200 (not shown), interlayer 206, and protective layer 203, and the second medium (of refractive index n₂) may be air. The critical angle, θ_{c}, is equal to:

$${θ}_{c} = {sin}^{- 1} \frac{{n}_{2}}{{n}_{1}} . \qquad a$$

Light incident at this angle and above is completely reflected back such that it remains inside the panel.

In some embodiments, the interlayer 206 may act as the pressure-sensitive layer. In other embodiments, a top layer, such as the protective layer 203, may act as the pressure-sensitive layer. In other embodiments, a top layer, protective layer 203, sensor layer 202, interlayer 206, substrate 200 or any combination thereof may comprise the pressure-sensitive layer. In other embodiments, a separate layer entirely may comprise the pressure-sensitive material, and may be incorporated into the panel 102 amongst the other layers (comprising the substrate 200, interlayer 206, sensor layer 202, and protective layer 203). However, these embodiments are provided merely for example only, and the skilled person will appreciate that any layers of the panel 102 may comprise the pressure-sensitive layer. In embodiments wherein the pressure-sensitive layer comprises the interlayer 206, the interlayer 206 may be the top layer of the panel (e.g., there may be no protective layer 203 and the interlayer comprises the sensor layer 202). In this exemplary embodiment, the interlayer may comprise PETG. In this case, the refractive index of the top layer (interlayer 206), for example, comprising PETG, is 1.57 (n₁), and the refractive index of air (n₂) is 1. The critical angle, according to the equation above, is therefore 39.6°. Therefore, if light is incident at this angle or greater, it will be totally internally reflected back into the panel 102.

In order for the object 204 under inspection to be illuminated as a result of the change in pressure, the material onto which the pressure is applied may have suitable properties to indicate the pressure change. Typically, said property is photoelasticity. Photoelasticity is where a change occurs in the refractive index of the material when stress is applied. Applying weight onto the panel will induce stress. In some embodiments, such as that shown in FIG. 17, the pressure-sensitive layer comprises protective layer 203. In some embodiments, the refractive index of the material (n₁), e.g., PETG, decreases due to this applied stress. For instance, say for example the refractive index decreases from 1.57 to 1.46, the critical angle will increase from 39.6° to 43.2°. This means that some incident light which had previously undergone total internal reflection (TIR) will “escape” from the panel and illuminate the foot. It will be appreciated that for other materials, such as PMMA, the refractive index may increase with applied stress. In the example of FIG. 17, light is coupled into the interlayer 206. As shown, applying a stress to the panel, for instance via the downward pressure 16 of a body part 204 (shown at point 302 of FIG. 17) causes light to escape, even though the angle of incidence θ₂ is greater than the angle of critical angle θ_{c1}, because the critical angle has increased to θ_{c2} at the point where pressure has been applied, such that θ_{c1}<0.2.

In preferred embodiments, such as that shown in FIG. 17, light is coupled to the interlayer 206 of the panel 102 and the top layer (such as protective layer 203) comprises photoelastic material, such that when pressure is applied, the top layer experiences a change in refractive index, thereby altering the critical angle and allowing light 17 to escape which would have otherwise been reflected. Preferably, the pressure-sensitive layer, or top layer, comprises protective layer 203, such that the other layers need not comprise photoelastic material. However, as stated, the interlayer 206, or sensor layer 202 or otherwise may comprise the photoelastic material and hence be pressure-sensitive.

When incorporating the pressure-sensing functionality into the panel, whereby the sensor layer 202 (e.g., a TLC polyester sheet) and a protective sheet 203, may be placed between the body part under inspection (e.g., a foot) and the interlayer 206, the illumination effect is attenuated by the air gap between the layers. However, in preferred embodiments, the layers in the panel may be adhered with index-matched optically clear adhesive 20. In the exemplary embodiment, the sensor layer 202 is backed with an optically clear adhesive, or any other suitable material which preferably has a refractive index matched, or closely matched, to those of interlayer 206 and the sensor layer 202, and protective layer 203. For instance, water may be used. Preferably, this optically clear adhesive 20, or otherwise, is adhered between the sensor layer 202 and protective layer 203. Preferably, the adhesive 20 is adhered between the sensor layer 202 and interlayer 206. In doing so, the illumination is unaffected as the air gap is largely or completely excluded by the optically clear adhesive 20, meaning the light can propagate through the material unaffected. Acrylic clear adhesives typically have a refractive index of n=1.475, which is well matched with PETG (n=1.57) and soda-lime glass (n=1.46), for example.

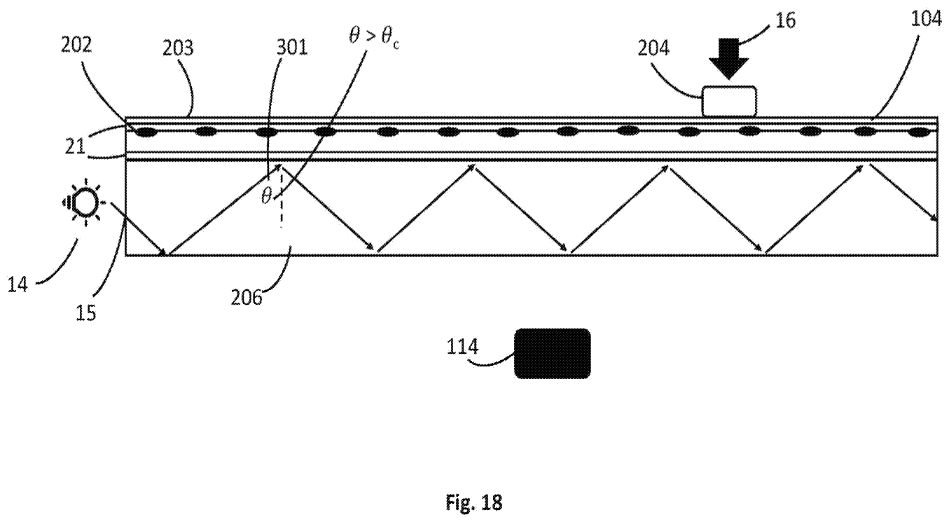

FIG. 18 is an exemplary diagram showing the effect where, rather than comprising an index-matched adhesive 20 between the layers, the panel instead comprises a non-index-matched adhesive (or airgap or otherwise) 21. This diagram demonstrates that, with the presence of a sensor layer 202, in turn comprising a TLC sheet, the illumination is significantly reduced or prevented entirely. Light is coupled into the interlayer 206, and applying a stress to the panel 102 in this case does not allow light to escape, as the layers in the panel are adhered with non-index-matched optically clear adhesive 21, or an air gap exists in the layer, meaning that light undergoes TIR 301 before it reaches the top layer.

FIG. 17 demonstrates that inclusion of the adhesive leaves the illumination unaffected. In some embodiments, for instance where the interlayer 206 comprises the pressure-sensitive layer, the pressure-sensitive layer is adhered to the sensor layer 202 (e.g., the TLC polyester sheet) using an optically clear adhesives 20 to expel any air gaps which would potentially suppress the illumination.

In preferred embodiments, the pressure-sensitive layer is of sufficient thickness to allow TIR to occur. Preferably, the pressure-sensitive layer is of sufficiently high refractive index (for instance, in the range of 1.3 to 1.7). Typically, the pressure-sensitive layer has photoelastic properties. In one exemplary arrangement, the photoelastic properties of the protective layer 203 may comprise an increase in refractive index of 1.24×10⁻⁶ per pascal of applied pressure. Preferably, the edges of the pressure-sensitive layer are suitable for edge-coupling. For instance, they may be sufficiently polished and straight. For efficient coupling of visible light, the surface is preferably visibly shiny, so that scattering of incident light is minimised-a shiny surface indicates that the roughness of the surface is on the order of the wavelength of light. Light incident on a smooth, straight surface (which is orthogonal to the incident light) will have minimal reflection compared with an angled surface. In some embodiments, one of the layers of the panel 102 may be suitable for edge coupling, while another layer comprises the pressure-sensitive layer. In the exemplary embodiment shown in FIG. 17, the protective layer 203 comprises the pressure-sensitive (photoelastic) layer, while the interlayer is edge coupled to the light source as it is typically of sufficient thickness. Optionally, the illumination source may be directed toward the edge of the pressure-sensitive layer and is angled at an angle sufficient for TIR. Preferably, the viewing angle into the pressure-sensitive layer is sufficiently wide for optimal illumination.

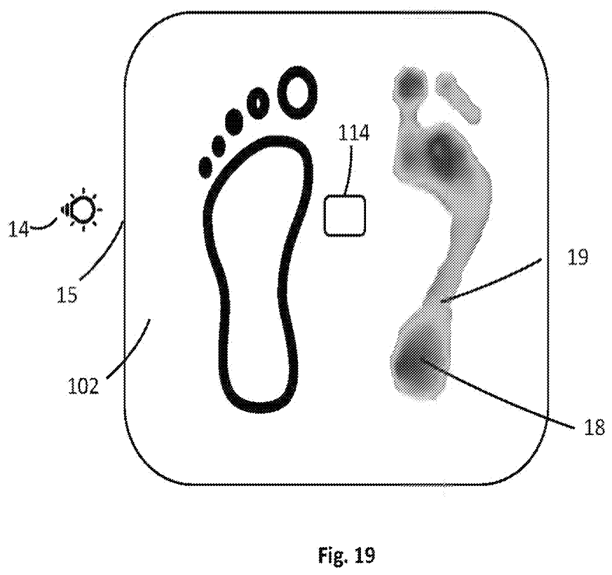

In preferred embodiments, the optical system (e.g., comprising image capture devices 114) can capture an image (or video) of the light which is projected onto the user's foot (or other body part under inspection). An area of higher pressure in the sensor panel will have less light undergoing TIR inside the panel, and consequently more light escaping from the panel and illuminating the target. Saturation is the intensity of a particular hue. The saturation of light in a particular area can then be quantified and correlated to the amount of pressure at a particular point or points of the target using an image processing algorithm or the like. Background light can be excluded from the calculation as the light coupled into the interlayer 206 is typically a specific wavelength/hue (e.g. red, green, blue). The relationship between saturation and applied pressure can be determined by a calibration procedure or suitable algorithm. FIG. 19 demonstrates how regions of high pressure in the foot will have increased illumination compared with regions of low pressure. The image capture devices 114, typically positioned below panel 102, are able to capture an image which shows that regions of higher pressure, denoted by reference numeral 18, result in greater, more saturated, or brighter illumination from the edge-coupled light source 14, when compared with regions of lower pressure, denoted by reference numeral 19. In other words, there is a greater light intensity escaping from regions of higher pressure compared with regions of lower pressure.

This embodiment offers several advantages. For instance, it allows the user to determine if and what parts of the foot are in contact with the panel, which can improve sensor temperature measurement accuracy. Other advantages include determining if the plantar pressure is abnormal or sub-optimal for the readings-if there is change in plantar pressure over time or over different measurements for a user, or if there is a difference in plantar pressure between the user's feet. Some or all of these measurements may be used to diagnose foot abnormalities in the patient. By allowing the user to determine if there was a change in the pressure applied between scans or during a single scan, the user can easily deduce how this may have affected the reading, and correct it.

The disclosure is not limited to the embodiment(s) described herein but can be amended or modified without departing from the scope of the present disclosure.

What is claimed is:

1. A panel for a skin inspection device, the panel comprising:
a substrate;
an array of temperature sensors;
an interlayer comprising a material for thermally insulating the temperature sensors from the substrate.

2. The panel as claimed in claim 1, wherein the interlayer is at least partially transparent.

3. The panel as claimed in claim 2, wherein the interlayer has an optical absorption coefficient between 0.02 cm⁻¹ to 0.5 cm⁻¹ at a light wavelength of 587 nm.

4. The panel as claimed in claim 1, wherein the interlayer has a sufficiently low thermal conductivity value, k.

5. The panel as claimed in claim 4, wherein the interlayer has a thermal conductivity k in the range 0.02 W/mK to 0.3 W/mK.

6. The panel as claimed in claim 1, wherein the interlayer is of sufficient thickness to thermally insulate the temperature sensors from the substrate.

7. The panel as claimed in claim 6, wherein the thickness of the interlayer is in the range 0.05 mm to 5 mm.

8. The panel as claimed in claim 7, wherein the thickness of the interlayer provides sufficient thermal insulation whilst maintaining the transparency of the interlayer.

9. The panel as claimed in claim 1, wherein the interlayer comprises at least one of the following materials: silica aerogel, air, Polyurethane (PU) foam, and transparent polymers such as polystyrene, polypropylene, polyester, PETG, PET, PMMA.

10. The panel as claimed in claim 1, wherein the substrate is at least partially transparent.

11. The panel as claimed in claim 1, wherein the substrate is of a Young's Modulus of at least 40 GPa to support the weight of an adult.

12. The panel as claimed in claim 1, wherein the substrate comprises glass.

13. The panel as claimed in claim 1, wherein the substrate comprises tempered glass.

14. The panel as claimed in claim 1, wherein the array of temperature sensors are provided on a carrier layer.

15. The panel as claimed in claim 14, wherein the carrier layer is at least partially transparent.

16. The panel as claimed in claim 1, further comprising a pressure-sensitive mechanism.

17. The panel as claimed in claim 16, wherein the pressure-sensitive mechanism comprises a pressure-sensitive layer.

18. The panel as claimed in claim 17 wherein the pressure-sensitive layer comprises photoelastic material.

19. The panel as claimed in claim 18, wherein the photoelastic material has a refractive index which changes with applied pressure.

20. A skin inspection device comprising the panel as claimed in claim 1, the skin inspection device configured to measure at least the temperature of an area of skin of one or more body parts.

21. The skin inspection device of claim 20, wherein the presence of the interlayer reduces the difference between the actual temperature of the area of skin and the temperature of the area of skin as measured by the skin inspection device.

22. The skin inspection device according to claim 20, wherein said device may be configured to allow the calculation of a temperature difference between two or more body parts.

23. The skin inspection device of claim 22, wherein the temperature of the ambient environment of said device has no effect on the deduced temperature difference between the two or more body parts.

24. The skin inspection device of claim 23, wherein said device is configured to measure the temperature of the ambient environment and prevent temperature measurements if the ambient environment temperature is not within a predetermined range.

25. The skin inspection device of claim 24, wherein the predetermined temperature range may be around 10° C. to 40° C.

26. The skin inspection device of claim 24, wherein said device comprises means by which to measure the temperature of the panel.

27. The skin inspection device of claim 26, wherein said device is configured to prevent temperature measurements if the panel temperature is not within a predetermined range.

28. A method of manufacturing a panel for a skin inspection device, the method comprising:
providing a substrate;
providing an array of temperature sensors;
providing an interlayer comprising a material for thermally insulating the temperature sensors from the substrate.

29. The method of claim 28, wherein the interlayer is at least partially transparent.

30. The method as claimed in claim 28, wherein the interlayer has a sufficiently low thermal conductivity value, k.

31. The method as claimed in claim 30, wherein the interlayer has a thermal conductivity k in the range 0.02 W/mK to 0.3 W/mK.

32. The method as claimed in claim 28, wherein the interlayer is of sufficient thickness to thermally insulate the temperature sensors from the substrate.

33. The method as claimed in claim 32, wherein the thickness of the interlayer is in the range 0.05 mm to 5 mm.

34. The method as claimed in claim 28, wherein the thickness of the interlayer provides sufficient thermal insulation whilst maintaining the transparency of the interlayer.

35. The method as claimed in claim 28, wherein the interlayer comprises at least one of the following materials: silica aerogel, air, Polyurethane (PU) foam, and transparent polymers such as polystyrene, polypropylene, polyester, PETG, PET, PMMA.
